(19) United States
(12) Patent Application Publication
(10) Pub. No.: US 2008/0280139 A1
(43) Pub. Date: Nov. 13, 2008

(54) Radiation-Curable Dispersible Polyurethanes and Polyurethane Dispersions

(76) Inventors: Eva Wagner, Bad Durkheim (DE); Erich Beck, Ladenburg (DE); Angelika Maria Steinbrecher, Stuttgart (DE); Yvonne Heischkel, Mannheim (DE); Reinhold Schwalm, Wachenheim (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/094,245

(22) PCT Filed: Nov. 23, 2006
(86) PCT No.: PCT/EP06/68825

§ 371 Date: May 19, 2008

(30) Foreign Application Priority Data
Dec. 1, 2005 (DE) 102005057684.2

(51) Int. Cl. C08L 75/04; C08G 18/02; B32B 27/40; C08F 2/46

(52) U.S. Cl. 428/402; 528/67; 524/591; 427/487

(57) ABSTRACT

The present invention relates to UV-curable, dispersible polyurethanes and polyurethane dispersions, to a process for preparing them, and to their use.

The present invention relates to UV-curable, dispersible polyurethanes and polyurethane dispersions, to a process for preparing them, and to their use.

Radiation-curable polyurethane dispersions are known for example from DE-A-44 34 554 and are prepared from polyisocyanates, hydroxyl-containing polyesters, compounds having an isocyanate-reactive group and an acid group, and compounds having an isocyanate-reactive group and C═C double bonds. In terms of their processing properties, however, the products leave something to be desired.

WO 01/23453 describes UV-curable and thermally curable polyurethane dispersions based on aliphatic polyisocyanates, which may include polyisocyanates containing allophanate groups. These dispersions mandatorily comprise isocyanate groups capped with an isocyanate-blocking agent, and as diol component comprise diols having a molecular weight of less than 500 g/mol.

DE-A-1 98 60 041 describes reaction products of a) polyisocyanates and b) low molecular weight hydroxyl compounds having C═C double bonds such as hydroxyalkyl (meth)acrylates or hydroxyalkyl vinyl ethers, which for the most part constitute allophanates of the polyisocyanates with the unsaturated alcohols. The low molecular weight, low-viscosity reaction products feature a high polymerizable C═C double bond content in the molecule and can be cured not only with UV radiation but also with the involvement of the isocyanate groups, by exposure to steam, ammonia or amines, for example. Application in the form of aqueous dispersions is not described.

EP 392352 describes aqueous dispersions of polyurethanes which can be crosslinked by exposure to high-energy radiation. They are synthesized from polyisocyanates, polyol, polyamine, amino alcohol, polyetherol, and hydroxyalkyl acrylate. They are used to coat leather. The coatings produced from the polyurethane acrylates described are not very hard.

Polyisocyanates containing allophanate groups are set out as starting compounds merely in a broad list equivalent with other polyisocyanates.

Weathering-stable polyurethanes curable by means of high-energy radiation are claimed by EP 1118627. The coatings are produced by drying films of a polyurethane dispersion prepared from polyisocyanates, cycloaliphatic diols and/or diamines, and NCO-reactive compounds having at least one unsaturated group and a group which is active in dispersion. The coatings produced in this way are weathering-stable. A disadvantage has proven to be the relatively low scratch resistance.

Polyisocyanates containing allophanate groups are set out as starting compounds merely in a broad list equivalent with other polyisocyanates.

The reaction conditions explicitly disclosed in the examples of EP 1118627 do not give rise to the formation of any allophanate groups.

EP 574775 describes reactive, water-emulsifiable binders and their use to prepare paints. The binders are based on polyurethane dispersions consisting of an acrylate-functional prepolymer, e.g., a polyester acrylate, one or more polyisocyanates, and a water-emulsifiable polyester. The coatings described exhibit only a low pendulum hardness of less than 100 s, which under mechanical load would lead to damage to the coating.

Polyisocyanates containing allophanate groups are set out as starting compounds merely in a broad list equivalent with other polyisocyanates.

The reaction conditions disclosed in the examples of EP 574775 do not give rise to formation of any allophanate groups.

Radiation-curable aqueous dispersions are likewise described in EP 753531. They are prepared from a polyester acrylate having an OH number of 40 to 120 mg KOH/g, a polyesterol or polyetherol, an emulsifiable group, di- or polyisocyanates. Optionally a salt formation, dispersing operation, and chain extension with diamines can be carried out. The ethylenically unsaturated group is introduced exclusively via a hydroxyl-containing prepolymer. Hence the opportunities to raise the double bond density are limited.

Polyisocyanates containing allophanate groups are set out as starting compounds merely in a broad list equivalent with other polyisocyanates.

The reaction conditions disclosed in the examples of EP 753531 likewise do not give rise to formation of any allophanate groups.

DE 10031258 describes curable aqueous polyurethane dispersions consisting of a hydroxyethyl acrylate allophanate, hydroxyalkyl acrylate, a polyol, polyamine or polythiol, at least one acid group and a basic compound, and a thermal initiator. The polyurethanes described additionally and mandatorily comprise a thermal initiator. This reduces the thermal stability. The concentration described for the acid groups, which are necessary for dispersing in water, is not sufficient to give dispersions which are stable on storage over several months. Furthermore, the hardness of the coatings obtained with these dispersions is in need of improvement.

U.S. Pat. No. 5,767,220 describes one-component coating materials containing allophanate groups and (meth)acrylate groups as a result of reaction of isocyanates with hydroxyalkyl (meth)acrylates and monofunctional or polyfunctional alcohols, which if appropriate, albeit less preferably, may have been alkoxylated.

The present invention is based on the object of providing UV-curable aqueous polyurethane dispersions. These dispersions ought to give rise to coatings having good performance properties, especially having good chemical resistance and/or good mechanical properties, in particular a high level of hardness in conjunction with high coating elasticity, a high scratch resistance, and, moreover, good storage stability.

This object is achieved by radiation-curable dispersible polyurethanes synthesized from
a) at least one compound having at least two free isocyanate groups, at least one allophanate group, and at least one free-radically polymerizable C═C double bond attached via the allophanate group, which is attached directly to the double bond a carbonyl group or an oxygen atom in ether function,
b) at least one compound having at least one, preferably precisely one group that is reactive toward isocyanate groups, and at least one free-radically polymerizable C═C double bond,
c) if appropriate, at least one compound having at least two groups that are reactive toward isocyanate groups, selected from hydroxyl, mercapto, and primary and/or secondary amino groups,
d) at least one compound having precisely one group that is reactive toward isocyanate, and at least one dispersive group,
e) if appropriate, at least one compound different from b) and d), containing precisely one group that is reactive toward isocyanate groups, and
f) if appropriate, at least one polyisocyanate different from a).

In one preferred embodiment the polyurethanes prepared inventively, i.e., the reaction products of synthesis components a) to d) and also, if appropriate, c), e) and/or f) have a double bond density of at least 1.3 mol/kg, preferably at least 1.8, more preferably at least 2.0.

In one preferred embodiment the amount of the curable groups, i.e., ethylenically unsaturated groups, is more than 2 mol/kg, preferably more than 2 mol/kg to 8 mol/kg, more preferably at least 2.1 mol/kg to 6 mol/kg, very preferably 2.2 to 6, in particular 2.3 to 5, and especially 2.5 to 5 mol/kg of the binder (solids), i.e. without water or other solvents.

The present invention further provides polyurethane dispersions which further to the dispersible polyurethanes with the synthesis components a) to e) comprise the following components:
g) absence of a thermal initiator,
h) if appropriate, further additives, selected from reactive diluents, photoinitiators, and customary coatings additives,
i) water, and
k) if appropriate, at least one diamine and/or polyamine.

In the dispersions of the invention preferably no isocyanate-functional compounds are used in which the isocyanate groups have been reacted in part or completely with what are called blocking agents. Blocking agents are compounds which convert isocyanate groups into blocked (capped or protected) isocyanate groups, which subsequently, below the temperature known as the deblocking temperature, do not display the customary reactions of a free isocyanate group. Such compounds with blocked isocyanate groups, which are preferably not used inventively, are commonly employed in dual-cure coating compositions which are cured to completion via isocyanate group curing. The polyurethane dispersions of the invention, following their preparation, preferably no longer contain essentially any free isocyanate groups: that is, in general, less than 1% by weight NCO, preferably less than 0.75%, more preferably less than 0.66%, and very preferably less than 0.3% by weight NCO (calculated with a molar weight of 42 g/mol).

### Component a)

Component a) comprises at least one compound having at least two free isocyanate groups, at least one allophanate group, and at least one free-radically polymerizable C═C double bond attached via the allophanate group, which is attached directly to the double bond a carbonyl group or an oxygen atom in ether function.

The component a) used inventively comprises according to the invention allophanate groups; preferably the amount of allophanate groups (calculated as C₂N₂HO₃=101 g/mol) is 1% to 35%, preferably from 5% to 30%, more preferably from 10% to 35% by weight. The polyurethanes of the invention formed from the synthesis components a) to d) and also, if appropriate, e) and f) comprise 1% to 30%, preferably from 1% to 25%, more preferably from 2% to 20% by weight of allophanate groups. The component a) used inventively further comprises less than 5% by weight of uretdione.

The inventively comprised compounds of component a) are preferably substantially free from other groups which form from isocyanate groups, particularly isocyanurate, biuret, oxadiazinetrione, iminooxadiazinetrione and/or carbodiimide groups, i.e., in each case less than 5% by weight, preferably less than 3, more preferably less than 2, very preferably less than 1 and especially less than 0.5% by weight.

Preferably component a) is selected from compounds of the general formula I

OCN—R¹-(R²—C(O)—R²—R¹)ₙ—NCO

in which
n is an integer from 1 to 10,
R¹ is a divalent aliphatic or alicyclic C₂ to C₂₀, preferably C₄ to C₁₂, more preferably C₆ to C₁₀ hydrocarbon unit or an aromatic C₆ to C₂₀, preferably C₆ to C₁₂ hydrocarbon unit,
R² in each repeating unit is —NH— or is

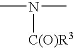

where R³ is a radical derived from an alcohol A by abstracting the hydrogen atom from the alcoholic hydroxyl group, the alcohol A additionally containing at least one free-radically polymerizable C═C double bond and there being attached directly to the double bond a carbonyl group or an oxygen atom in ether linkage, preferably via a carbonyl group.

The radicals R¹ are preferably radicals derived by abstracting the isocyanate group from customary aliphatic, cycloaliphatic or aromatic polyisocyanates. The diisocyanates are preferably aliphatic isocyanates having 4 to 20 carbon atoms. Examples of customary diisocyanates are aliphatic diisocyanates such as tetramethylene 1,4-diiso-cyanate, hexamethylene 1,6-diisocyanate, 2-methyl 1,5-diisocyanatopentane, octamethylene 1,8-diisocyanate, decamethylene 1,10-diisocyanate, dodecamethylene 1,12-diisocyanate, tetradecamethylene diisocyanate, 2,2,4- and 2,4,4-trimethylhexane diisocyanate, derivatives of lysine diisocyanate, tetramethylxylylene diisocyanate, cycloaliphatic diisocyanates such as 1,4-, 1,3- or 1,2-diisocyanatocyclohexane, 4,4′- or 2,4′-di(isocyanatocyclohexyl)methane, isophorone diisocyanate, 1,3- or 1,4-bis-(isocyanatomethyl)cyclohexane, 2,4- and 2,6-diisocyanato-1-methylcyclohexane, and also 3(or 4), 8(or 9)-bis(aminomethyl)tricyclo[5.2.1.0^{2,6}]decane isomer mixtures, and also aromatic diisocyanates such as tolylene 2,4- or 2,6-diisocyanate, m- or p-xylylene diisocyanate, 2,4′- or 4,4′-diisocyanatodiphenylmethane, phenylene 1,3- or 1,4-diiso-cyanate, 1-chlorophenylene 2,4-diisocyanate, naphthylene 1,5-diisocyanate, diphenylene 4,4′-diisocyanate, 4,4′-diisocyanato-3,3′-dimethyldiphenyl diisocyanate, 3-methyldiphenylmethane 4,4′-diisocyanate, and diphenyl ether 4,4′-diisocyanate. Mixtures of said diisocyanates may be present.

Preference is given to hexamethylene 1,6-diisocyanate, 1,3-bis(isocyanatomethyl)cyclohexane, isophorone diisocyanate, tetramethylxylylene diisocyanate, and di(isocyanatocyclohexyl)methane.

Mixtures of said diisocyanates may also be present.

2,2,4- and 2,4,4-trimethylhexane diisocyanate are present in the form, for example, of a mixture in a ratio of 1.5:1 to 1:1.5, preferably 1.2:1-1:1.2, more preferably 1.1:1-1:1.1, and very preferably 1:1.

Isophorone diisocyanate is present, for example, in the form of a mixture, specifically a mixture of the cis and trans isomers, generally in a ratio of about 60:40 to 80:20 (w/w), preferably in a ratio of about 70:30 to 75:25, and more preferably in a ratio of about 75:25.

Dicyclohexylmethane 4,4′-diisocyanate may likewise be present in the form of a mixture of the different cis and trans isomers.

Aromatic isocyanates are those comprising at least one aromatic ring system.

Cycloaliphatic isocyanates are those comprising at least one cycloaliphatic ring system.

Aliphatic isocyanates are those comprising exclusively linear or branched chains, i.e., acyclic compounds.

The alcohols A from which radical R³ derives are, for example, esters of α,β-unsaturated carboxylic acids, such as acrylic acid, methacrylic acid (“(meth)acrylic acid” for short below), crotonic acid, acrylamidoglycolic acid, methacrylamidoglycolic acid or vinylacetic acid, preferably acrylic acid and methacrylic acid, and more preferably acrylic acid, and polyols, preferably diols, having preferably 2 to 20 carbon atoms and at least 2, preferably precisely two hydroxyl groups, such as ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)iso-propylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctan-1,3-diol, hydroquinone, bisphenol A, bisphenol F, bisphenol B, bisphenol S, 2,2-bis(4-hydroxycyclohexyl)propane, 1,1-, 1,2-, 1,3- and 1,4-cyclohexanedimethanol, 1,2-, 1,3- or 1,4-cyclohexanediol, trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (Iyxitol), xylitol, dulcitol (galactitol), maltitol or isomalt, with the proviso that the ester contains at least one, preferably precisely one isocyanate-reactive OH group. The radicals R³ may also derive, additionally, from the amides of (meth)acrylic acid with amino alcohols, examples being 2-aminoethanol, 3-amino-1-propanol, 1-amino-2-propanol or 2-(2-aminoethoxy)ethanol, and from the vinyl ethers of the aforementioned polyols, provided they still contain a free OH group.

Preferably the radicals R³ derive from alcohols A such as 2-hydroxyethyl (meth)acrylate, 2- or 3-hydroxypropyl (meth)acrylate, 1,4-butanediol mono(meth)acrylate, neopentyl glycol mono(meth)acrylate, glyceryl mono- and di(meth)acrylate, trimethylolpropane mono- and di(meth)acrylate and pentaerythrityl di- and tri(meth)acrylate. With particular preference the alcohol A is selected from 2-hydroxyethyl acrylate, 2-hydroxyethyl methacrylate, and hydroxypropyl (meth)acrylate. With very particular preference the alcohol A is 2-hydroxyethyl acrylate. Examples of amides of ethylenically unsaturated carboxylic acids with amino alcohols are hydroxyalkyl(meth)acrylamides such as N-hydroxymethyl(meth)acrylamide, N-hydroxyethyl(meth)acrylamide, 5-hydroxy-3-oxopentyl(meth)acrylamide, N-hydroxyalkylcrotonamides such as N-hydroxymethylcrotonamide, or N-hydroxyalkylmaleimides such as N-hydroxyethylmaleimide.

The preparation of component a) is not essential in accordance with the invention. Preferably it takes place as described in WO 00/39183. Also possible, however, is a preparation of component a) as described in DE 102 46 512. The disclosure content of these two publications in relation to the preparation of the inventively essential component a) is hereby incorporated by reference as part of the present description.

### Component b)

Component b) comprises at least one compound having at least one, preferably precisely one group that is reactive toward isocyanate groups, and at least one free-radically polymerizable C═C double bond.

Preferred compounds of components b) are, for example, the esters of dihydric or polyhydric alcohols with α,β-ethylenically unsaturated monocarboxylic and/or dicarboxylic acids and their anhydrides. Examples of α,β-ethylenically unsaturated monocarboxylic and/or dicarboxylic acids and their anhydrides that can be used include acrylic acid, methacrylic acid, fumaric acid, maleic acid, maleic anhydride, crotonic acid, itaconic acid, etc. It is preferred to use acrylic acid and methacrylic acid, more preferably acrylic acid.

Examples of suitable alcohols are diols such as ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)isopropylidene, tetramethylcyclobutanediol, 1,2-, 1,3- or 1,4-cyclo-hexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3- or 1,4-cyclohexanediol, and tricyclodecanedimethanol.

Suitable triols and polyols have, for example, 3 to 25, preferably 3 to 18, carbon atoms. Examples include trimethylolbutane, trimethylolpropane, trimethylolethane, pentaerythritol, glycerol, ditrimethylolpropane, dipentaerythritol, ditrimethylolpropane, sorbitol, mannitol, diglycerol, threitol, erythritol, adonitol (ribitol), arabitol (Iyxitol), xylitol, dulcitol (galactitol), maltitol or isomalt.

All compounds as listed above as compounds A are suitable.

Preferably the compounds of component b) are selected from 2-hydroxyethyl acrylate, 2-hydroxyethyl methacrylate, 2-hydroxypropyl acrylate, 2-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, trimethylolpropane mono- or diacrylate, pentaerythrityl di- or triacrylate, and mixtures thereof.

Particular preference is given to 2-hydroxyethyl acrylate, 2-hydroxyethyl methacrylate, 2-hydroxypropyl acrylate, 2-hydroxypropyl methacrylate, and pentaerythritol triacrylate.

The compound b) can be the same compound as the alcohol A used in component a), or can be different from said alcohol. Preferably the compounds b) are an alcohol A different from those used in component a).

Possible compounds b) are, furthermore, esters of the abovementioned α,β-unsaturated acids, preferably (meth)acrylates, more preferably acrylates of compounds of the formula (Ia) to (Ic),

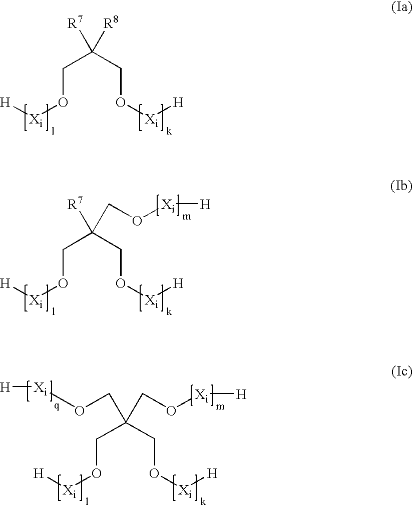

in which
R⁷ and R⁸ independently of one another are hydrogen or optionally aryl-, alkyl-, aryloxy-, alkyloxy-, heteroatom- and/or heterocycle-substituted C₁-C₁₈ alkyl,
k, l, m and q independently of one another are each an integer from 1 to 15, preferably 1 to 10, and more preferably 1 to 7, and
each Xᵢ for i=1 to k, 1 to l, 1 to m, and 1 to q, can be selected independently of the others from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group —CH₂—CH₂—O—, —CH₂—CH(CH₃)—O—, and —CH(CH₃)—CH₂—O—, and more preferably —CH₂—CH₂—O—,
in which Ph stands for phenyl and Vin stands for vinyl.

Optionally aryl-, alkyl-, aryloxy-, alkyloxy-, heteroatom- and/or heterocycle-substituted C₁-C₁₈ alkyl is, for example, methyl, ethyl, propyl, isopropyl,

n-butyl, sec-butyl, tert-butyl, pentyl, hexyl, heptyl, octyl, 2-ethylhexyl, 2,4,4-trimethyl-pentyl, decyl, dodecyl, tetradecyl, heptadecyl, octadecyl, 1,1-dimethylpropyl, 1,1-dimethylbutyl, 1,1,3,3-tetramethylbutyl, preferably methyl, ethyl or n-propyl, very preferably methyl or ethyl.

Preferably the compounds in question are (meth)acrylates of singly to trigintuply and more preferably triply to vigintuply ethoxylated, propoxylated or mixedly ethoxylated and propoxylated, and in particular exclusively ethoxylated, neopentyl glycol, trimethylolpropane, trimethylolethane or pentaerythritol.

Suitable compounds b) are, furthermore, the esters and amides of amino alcohols with the aforementioned α,β-ethylenically unsaturated monocarboxylic and/or dicarboxylic acids, hydroxyalkyl vinyl ethers such as 4-hydroxybutyl vinyl ether etc.

### Component c)

Optional component c) is at least one compound having at least two groups that are reactive toward isocyanate groups, selected from hydroxyl, mercapto, and primary and/or secondary amino groups.

Suitable compounds c) are low molecular weight alcohols c1) and/or polymeric polyols c2), preferably compounds c1).

Low molecular weight alcohols c1) have a molecular weight of not more than 500 g/mol. Particularly preferred are alcohols having 2 to 20 carbon atoms and 2 to 6 hydroxyl groups, such as the aforementioned glycols. Preference is given in particular to hydrolysis-stable, short-chain diols having 4 to 20, preferably 6 to 12, carbon atoms. Such compounds include, preferably, 1,1-, 1,2-, 1,3- or 1,4-di(hydroxymethyl)cyclohexane, bis(hydroxycyclohexyl)propane, tetramethylcyclobutanediol, cyclooctanediol or norbornanediol. Aliphatic hydrocarbon diols are particularly preferred for use, such as the isomeric butanediols, pentanediols, hexanediols, heptanediols, octanediols, nonanediols, decanediols, undecanediols, and dodecanediols. Particular preference is given to 1,2-, 1,3- or 1,4-butanediol, 1,4-pentanediol, 1,5-pentanediol, 1,6-hexanediol, 2,5-hexanediol, dihydroxymethyl-cyclohexane, bishydroxycyclohexylpropane, etc.

Suitable compounds c2) are, furthermore, polymeric polyols. The number-average molecular weight Mₙ of these polymers is preferably situated within a range from about 500 to 100 000, more preferably 500 to 10 000. The OH numbers are situated preferably in a range from about 20 to 300 mg KOH/g polymer.

Examples of preferred polymers c2) are copolymers which comprise in copolymerized form at least one of the aforementioned monoesters of dihydric or polyhydric alcohols with at least one α,β-ethylenically unsaturated monocarboxylic and/or dicarboxylic acid and at least one further comonomer, preferably selected from vinylaromatics, such as styrene, esters of the aforementioned α,β-unsaturated monocarboxylic and/or dicarboxylic acids with monoalcohols, vinyl esters of carboxylic acids comprising up to 20 carbon atoms, vinyl halides, nonaromatic hydrocarbons having 4 to 8 carbon atoms and 1 or 2 double bonds, unsaturated nitriles, etc., and mixtures thereof. They further include (partially) hydrolyzed vinyl ester polymers, preferably polyvinyl acetates.

They further include polyesterols based on aliphatic, cycloaliphatic and/or aromatic dicarboxylic, tricarboxylic and/or polycarboxylic acids with diols, triols and/or polyols, and also lactone-based polyesterols.

Polyesterpolyols are known for example from Ullmanns Encyklopädie der technischen Chemie, 4th edition, volume 19, pp. 62 to 65. Preference is given to using polyesterpolyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyesterpolyols. The polycarboxylic acids may be aliphatic, cycloaliphatic, araliphatic, aromatic or heterocyclic and may if appropriate be substituted, by halogen atoms for example, and/or unsaturated. Examples thereof that may be mentioned include the following:

Oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄-alkyl esters for example, preferably methyl, ethyl or n-butyl esters, of said acids are used. Preference is given to dicarboxylic acids of the general formula HOOC—(CH₂)_{y}—COOH, y being a number from 1 to 20, preferably an even number from 2 to 20; more preferably succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF having a molar mass between 162 and 2000, poly-1,3-propanediol having a molar mass between 134 and 2000, poly-1,2-propanediol having a molar mass between 134 and 2000, polyethylene glycol having a molar mass between 106 and 2000, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (Iyxitol), xylitol, dulcitol (galactitol), maltitol or isomalt, which if appropriate may have been alkoxylated as described above.

Preferred alcohols are those of the general formula HO—(CH₂)ₓ—OH, x being a number from 1 to 20, preferably an even number from 2 to 20. Preference is given to ethylene glycol, butane-1,4-diol, hexane-1,6-diol, octane-1,8-diol, and dodecane-1,12-diol. Preference is further given to neopentyl glycol.

Also suitable, furthermore, are polycarbonate-diols, such as may be obtained, for example, by reacting phosgene with an excess of the low molecular weight alcohols specified as synthesis components for the polyesterpolyols.

Also suitable are lactone-based polyesterdiols, which are homopolymers or copolymers of lactones, preferably hydroxy-terminated adducts of lactones with suitable difunctional starter molecules. Suitable lactones include, preferably, those deriving from compounds of the general formula HO—(CH₂)_{z}—COOH, z being a number from 1 to 20 and it being possible for an H atom of a methylene unit to have been substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Examples of suitable starter components are the low molecular weight dihydric alcohols specified above as a synthesis component for the polyesterpolyols. The corresponding polymers of ε-caprolactone are particularly preferred. Lower polyesterdiols or polyetherdiols as well can be used as starters for preparing the lactone polymers. In lieu of the polymers of lactones it is also possible to use the corresponding, chemically equivalent polycondensates of the hydroxy carboxylic acids corresponding to the lactones.

Further included here are polyetherols, which are obtainable by polymerizing cyclic ethers or by reacting alkylene oxides with a starter molecule, and also α,ω-diamino polyethers obtainable by reacting polyetherols with ammonia.

Examples thereof are the products generally known as Jeffamines® from Huntsman.

The Jeffamines® specified here are mono-, di- or triamines which are based on polyethers, polyethylene oxides, polypropylene oxides or mixed polyethylene oxides/polypropylene oxides and which may have a molar mass of up to about 5000 g/mol.

Examples of monoamines of this kind are the so-called Jeffamine® M series, which constitute methyl-capped polyalkylene oxides having an amino function, such as M-600 (XTJ-505), having a propylene oxide (PO)/ethylene oxide (EO) ratio of about 9:1 and a molar mass of about 600, M-1000 (XTJ-506):PO/EO ratio 3:19, molar mass about 1000, M-2005 (XTJ-507):PO/EO ratio 29:6, molar mass about 2000 or M-2070:PO/EO ratio 10:31, molar mass about 2000.

Examples of diamines of such kind are those known as Jeffamine® D or ED series. The D series are amino-functionalized polypropylenediols comprising 3-4 1,2-propylene units (Jeffamine® D-230, average molar mass 230), 6-7 1,2-propylene units (Jeffamine® D-400, average molar mass 400), on average about 34 1,2-propylene units (Jeffamine® D-2000, average molar mass 2000) or on average about 69 1,2-propylene units (Jeffamine® XTJ-510 (D-4000), average molar mass 4000). These products may also be partly in the form of amino alcohols. The ED series are diamines based on polyethylene oxides, which idealizedly are propoxylated at both ends; for example, Jeffamine® HK-511 (XTJ-511) comprising 2 ethylene oxide and 2 propylene oxide units, with an average molar mass of 220, Jeffamine® XTJ-500 (ED-600) comprising 9 ethylene oxide and 3.6 propylene oxide units, with an average molar mass of 600, and Jeffamine® XTJ-502 (ED-2003) comprising 38.7 ethylene oxide and 6 propylene oxide units, with an average molar mass of 2000.

Examples of triamines are Jeffamine® T-403, a triamine based on a trimethylolpropane modified with 5-6 1,2-propylene units, Jeffamine® T-5000, a triamine based on a glycerol modified with about 85 1,2-propylene units, and Jeffamine® XTJ-509 (T-3000), a triamine based on a glycerol modified with 50 1,2-propylene units.

The aforementioned components c) can be used individually or as mixtures.

### Component d)

Suitable components d) are compounds having precisely one isocyanate-reactive group and at least one, preferably precisely one, dispersive group.

Compounds d) having more than one isocyanate-reactive group are expressly excluded in accordance with the invention.

The dispersive groups can be

d1) anionic groups or groups which can be converted into an anionic group,
d2) cationic groups or groups which can be converted into a cationic group, or
d3) nonionic groups.

It will be appreciated that mixtures are also conceivable.

In accordance with the invention the compounds d) are compounds comprising no polymerizable C—C bonds.

Compounds d1) comprise precisely one group that is reactive toward isocyanate groups, and at least one hydrophilic group which is anionic or can be converted into an anionic group. The compounds in question are, for example, those as described in EP-A1 703 255, particularly from page 3 line 54 to page 4 line 38 therein, in DE-A1 197 24 199, particularly from page 3 lines 4 to 30 therein, in DE-A1 40 10 783, particularly from column 3 lines 3 to 40 therein, in DE-A1 41 13 160, particularly from column 3 line 63 to column 4 line 4 therein, and in EP-A2 548 669, particularly from page 4 line 50 to page 5 line 6 therein. These publications are hereby expressly incorporated by reference as part of the present disclosure content.

Preferred compounds d1) are those having the general formula

RG-R⁹-DG

in which
RG is at least one isocyanate-reactive group,
DG is at least one dispersive group, and
R⁹ is an aliphatic, cycloaliphatic or aromatic radical comprising 1 to 20 carbon atoms.

Examples of isocyanate-reactive groups RG are —OH, —SH, —NH₂ or —NHR¹⁰, in which R¹⁰ is as defined above but can be different from the radical used there; preferably —OH, —NH₂ or —NHR¹⁰; more preferably —OH or —NH₂; and very preferably —OH.

Examples of DG are —COOH, —SO₃H or —PO₃H and also their anionic forms, with which any desired counterion may be associated, examples being Li⁺, Na⁺, K⁺, Cs⁺, Mg²⁺, Ca²⁺ or Ba²⁺. Other possible associated counterions are the quaternary ammonium ions or those ammonium ions that are derived from ammonia or amines, especially tertiary amines, such as, for example, ammonium, methylammonium, dimethylammonium, trimethylammonium, ethylammonium, diethylammonium, triethylammonium, tributylammonium, diisopropylethylammonium, benzyldimethyl-ammonium, monoethanolammonium, diethanolammonium, triethanolammonium, hydroxyethyldimethylammonium, hydroxyethyldiethylammonium, monopropanol-ammonium, dipropanolammonium, tripropanolammonium, piperidinium, piperazinium, N,N′-dimethylpiperazinium, morpholinium, pyridinium, tetramethylammonium, triethylmethylammonium, 2-hydroxyethyltrimethylammonium, bis(2-hydroxyethyl)-dimethylammonium or tris(2-hydroxyethyl)methylammonium.

R⁹ is preferably methylene, 1,2-ethylene, 1,2-propylene, 1,3-propylene, 1,2-butylene, 1,4-butylene, 1,3-butylene, 1,6-hexylene, 1,8-octylene, 1,12-dodecylene, 1,2-phenylene, 1,3-phenylene, 1,4-phenylene, 1,2-naphthylene, 1,3-naphthylene, 1,4-naphthylene, 1,6-naphthylene, 1,2-cyclopentylene, 1,3-cyclopentylene, 1,2-cyclo-hexylene, 1,3-cyclohexylene or 1,4-cyclohexylene.

Component d1) is preferably, for example, hydroxyacetic acid, tartaric acid, lactic acid, 3-hydroxypropionic acid, hydroxypivalic acid, mercaptoacetic acid, mercaptopropionic acid, thiolactic acid, mercaptosuccinic acid, glycine, iminodiacetic acid, sarcosine, alanine, β-alanine, leucine, isoleucine, aminobutyric acid, hydroxysuccinic acid, hydroxydecanoic acid, ethylenediaminetriacetic acid, hydroxydodecanoic acid, hydroxyhexadecanoic acid, 12-hydroxystearic acid, aminonaphthalenecarboxylic acid, hydroxyethanesulfonic acid, hydroxypropanesulfonic acid, mercaptoethanesulfonic acid, mercaptopropanesulfonic acid, aminomethanesulfonic acid, taurine, aminopropanesulfonic acid, N-alkylated or N-cycloalkylated aminopropanesulfonic or aminoethanesulfonic acids, examples being N-cyclohexylaminoethanesulfonic acid or N-cyclohexylaminopropanesulfonic acid, and also the alkali metal, alkaline earth metal or ammonium salts thereof, and more preferably the aforementioned monohydroxy-carboxylic and monohydroxysulfonic acids and monoaminocarboxylic and monoaminosulfonic acids.

For the preparation of the dispersion, the aforementioned acids, if not already in salt form, are partly or fully neutralized, preferably with alkali metal salts or amines, preferably tertiary amines.

Compounds d2) comprise precisely one group that is reactive toward isocyanate groups, and at least one hydrophilic group that is cationic or can be converted into a cationic group, and are, for example, compounds of the type described in EP-A1 582 166, particularly from page 5 line 42 to page 8 line 22 and especially from page 9 line 19 to page 15 line 34 therein, or in EP-A1 531 820, particularly from page 3 line 21 to page 4 line 57 therein, or in DE-A1 42 03 510, particularly from page 3 line 49 to page 5 line 35 therein. These publications are expressly incorporated by reference as part of the present disclosure content.

Potentially cationic compounds d2) of particular practical importance are especially those containing tertiary amino groups, examples including the following: N-hydroxyalkyldialkylamines, N-aminoalkyldialkylamines, the alkyl radicals and alkanediyl units of these tertiary amines being composed independently of one another of 2 to 6 carbon atoms. Also suitable are polyethers containing tertiary nitrogen atoms and having a terminal hydroxyl group, such as, for example, by alkoxylation of secondary amines. Polyethers of this kind have in general a molar weight situated between 500 and 6000 g/mol.

These tertiary amines are converted into the ammonium salts either with acids, preferably strong mineral acids such as phosphoric acid, sulfuric acid or hydrohalic acids, strong organic acids, such as formic, acetic or lactic acid, for example, or by reaction with suitable quaternizing agents such as C₁ to C₆ alkyl halides, bromides or chlorides for example, or di-C₁ to C₆ alkyl sulfates or di-C₁ to C₆ alkyl carbonates.

Suitable compounds d2) having isocyanate-reactive amino groups include aminocarboxylic acids such as lysine, β-alanine, the adducts, specified in DE-A2034479, of aliphatic diprimary diamines with α,β-unsaturated carboxylic acids such as N-(2-aminoethyl)-2-aminoethane carboxylic acid, and also the corresponding N-aminoalkylaminoalkylcarboxylic acids, the alkanediyl units being composed of 2 to 6 carbon atoms.

Where monomers containing potentially ionic groups are employed, their conversion into the ionic form may take place before or during, but preferably after, the isocyanate polyaddition, since the ionic monomers frequently dissolve only sparingly in the reaction mixture. With particular preference the carboxylate groups are in the form of their salts with an alkali metal ion or ammonium ion as counterion.

Compounds d3) are monofunctional polyalkylene oxide polyether alcohols obtainable by alkoxylation of suitable starter molecules.

Suitable starter molecules for preparing such polyalkylene oxide polyether alcohols are thiol compounds, monohydroxy compounds of the general formula

R¹⁴—O—H

or secondary monoamines of the general formula

R¹²R¹³N—H,

in which
R¹², R¹³, and R¹⁴ each independently of one another are C₁-C₁₈ alkyl, a five- to six-membered, nitrogen, oxygen and/or sulfur atom-containing heterocycle, C₅-C₁₂ cycloalkyl, C₆-C₁₂ aryl or C₂-C₁₈ alkyl optionally interrupted by one or more oxygen and/or sulfur atoms and/or by one or more substituted or unsubstituted imino groups, or R¹² and R¹³ together form an unsaturated, saturated or aromatic ring which is optionally interrupted by one or more oxygen and/or sulfur atoms and/or by one or more substituted or unsubstituted imino groups, it being possible for the stated radicals each to be substituted by functional groups, aryl, alkyl, aryloxy, alkyloxy, halogen, heteroatoms and/or heterocycles.

Preferably R¹², R¹³, and R¹⁴ independently of one another are C₁ to C₄ alkyl, more preferably R¹², R¹³, and R¹⁴ are methyl.

Monofunctional starter molecules suitable by way of example can be saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, cyclopentanol, the isomeric methylcyclohexanols or hydroxymethylcyclohexane, 3-ethyl-3-hydroxymethyloxetane, or tetrahydrofurfuryl alcohol; aromatic alcohols such as phenol, the isomeric cresols or methoxyphenols, araliphatic alcohols such as benzyl alcohol, anisyl alcohol or cinnamyl alcohol; secondary monoamines such as dimethylamine, diethylamine, dipropylamine, diisopropylamine, di-n-butylamine, diisobutylamine, bis(2-ethylhexyl)amine, N-methyl- and N-ethylcyclohexylamine or dicyclohexylamine, heterocyclic secondary amines such as morpholine, pyrrolidine, piperidine or 1H-pyrazole, and also amino alcohols such as 2-dimethylaminoethanol, 2-diethylaminoethanol, 2-diisopropylaminoethanol, 2-dibutylaminoethanol, 3-(dimethylamino)-1-propanol or 1-(dimethylamino)-2-propanol.

Preferred starter molecules are alcohols having not more than 6 carbon atoms, more preferably having not more than 4 carbon atoms, very preferably having not more than 2 carbon atoms, and in particular, methanol.

Alkylene oxides suitable for the alkoxylation reaction are ethylene oxide, propylene oxide, isobutylene oxide, vinyloxirane and/or styrene oxide, which can be used in any order or else in a mixture for the alkoxylation reaction.

Preferred alkylene oxides are ethylene oxide, propylene oxide and mixtures thereof, ethylene oxide is particularly preferred.

Preferred polyether alcohols are those based on polyalkylene oxide polyether alcohols prepared using saturated aliphatic or cycloaliphatic alcohols of the aforementioned kind as starter molecules. Very particular preference is given to those based on polyalkylene oxide polyether alcohols prepared using saturated aliphatic alcohols having 1 to 4 carbon atoms in the alkyl radical. Particular preference is given to polyalkylene oxide polyether alcohols prepared starting from methanol.

The monofunctional polyalkylene oxide polyether alcohols have on average in general at least 2 alkylene oxide units, preferably 5 ethylene oxide units, per molecule, in copolymerized form, more preferably at least 7, very preferably at least 10, and in particular at least 15.

The monofunctional polyalkylene oxide polyether alcohols have on average in general up to 50 alkylene oxide units, preferably ethylene oxide units, per molecule, in copolymerized form, preferably up to 45, more preferably up to 40, and very preferably up to 30.

The molar weight of the monofunctional polyalkylene oxide polyether alcohols is preferably up to 2000, more preferably not more than 1000 g/mol, with very particular preference 500±1000 g/mol.

Preferred polyether alcohols are therefore compounds of the formula

R¹⁴—O—[—Yᵢ—]ₚ—H

in which
R¹⁴ is as defined above,
p is an integer from 2 to 50, preferably 5 to 45, more preferably 7 to 40, and very preferably 10 to 30, and
each Yᵢ for i=1 to p can be selected independently of one another from the group composed of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O— and —CHPh-CH₂—O—, preferably from the group —CH₂—CH₂—O—, —CH₂—CH(CH₃)—O— and —CH(CH₃)—CH₂—O—, and more preferably —CH₂—CH₂—O—
in which Ph stands for phenyl and Vin stands for vinyl.

Preferred compounds d) are d1) and d3), more preferably compounds d1).

### Component e)

In the polyurethane dispersions or polyurethanes of the invention as optional component e) it is possible to use at least one further compound having precisely one group which is reactive toward isocyanate groups. This group can be a hydroxyl or mercapto group or a primary or secondary amino group. Suitable compounds e) are the customary compounds known to the skilled worker, which are used conventionally in polyurethane preparation as stoppers for lowering the number of reactive free isocyanate groups or for modifying the polyurethane properties. Examples include monofunctional alcohols, such as methanol, ethanol, n-propanol, isopropanol, n-butanol etc. Suitable components e) are also amines having one primary or secondary amino group, such as methylamine, ethylamine, n-propylamine, diisopropylamine, dimethylamine, diethylamine, di-n-propylamine, diisopropylamine etc.

### Component f)

In the polyurethane dispersions or polyurethanes of the invention it is possible as optional component f) to use at least one polyisocyanate which is different from the compounds of components a). As components f) in accordance with the invention no use is made of polyisocyanates where the isocyanate groups have been reacted with a blocking agent.

Preferred compounds f) are polyisocyanates having an NCO functionality of 2 to 4.5, more preferably 2 to 3.5. As component f) it is preferred to use aliphatic, cycloaliphatic and araliphatic diisocyanates. These may be, for example, the diisocyanates set out above under a), but are different from the compound a) actually used in the polyurethane. Preferred compounds f) have 2 or more isocyanate groups and also a group selected from the group of urethane, urea, biuret, allophanate, carbodiimide, urethonimine, uretdione, and isocyanurate groups.

These are, for example
1) Polyisocyanates containing isocyanurate groups and derived from aromatic, aliphatic and/or cycloaliphatic diisocyanates. Particularly preferred here are the corresponding aliphatic and/or cycloaliphatic isocyanato-isocyanurates and, in particular, those based on hexamethylene diisocyanate and isophorone diisocyanate. The isocyanurates present in this case are, in particular, trisisocyanatoalkyl and/or trisisocyanatocycloalkyl isocyanurates, which constitute cyclic trimers of the diisocyanates, or are mixtures with their higher homologs containing more than one isocyanurate ring. The isocyanato-isocyanurates generally have an NCO content of 10% to 30% by weight, in particular 15% to 25% by weight, and an average NCO functionality of 2.6 to 4.5.
2) Uretdione diisocyanates having aromatically, aliphatically and/or cycloaliphatically attached isocyanate groups, preferably aliphatically and/or cycloaliphatically attached groups, and in particular those derived from hexamethylene diisocyanate or isophorone diisocyanate. Uretdione diisocyanates are cyclic dimerization products of diisocyanates.
The uretdione diisocyanates may be used in accordance with the invention as a sole component or in a mixture with other polyisocyanates, particularly those specified under 1).
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 22% by weight and an average NCO functionality of 2.8 to 4.5.
4) Polyisocyanates containing urethane groups and/or allophanate groups and having aromatically, aliphatically or cycloaliphatically attached, preferably aliphatically or cycloaliphatically attached, isocyanate groups, such as are obtainable, for example, by reacting excess amounts of hexamethylene diisocyanate or of isophorone diisocyanate with monohydric or polyhydric alcohols such as, for example, methanol, ethanol, isopropanol, n-propanol, n-butanol, isobutanol, sec-butanol, tert-butanol, n-hexanol, n-heptanol, n-octanol, n-decanol, n-dodecanol (lauryl alcohol), 2-ethylhexanol, n-pentanol, stearyl alcohol, cetyl alcohol, lauryl alcohol, ethylene glycol monomethyl ether, ethylene glycol monoethyl ether, 1,3-propanediol monomethyl ether, cyclopentanol, cyclohexanol, cyclooctanol, cyclododecanol, trimethylolpropane, neopentyl glycol, pentaerythritol, 1,4-butanediol, 1,6-hexanediol, 1,3-propanediol, 2-ethyl-1,3-propanediol, 2-methyl-1,3-propanediol, ethylene glycol, diethylene glycol, triethylene glycol, tetraethylene glycol, pentaethylene glycol, glycerol, 1,2-dihydroxypropane, 2,2-dimethyl-1,2-ethanediol, 1,2-butanediol, 1,4-butane-diol, 3-methylpentane-1,5-diol, 2-ethylhexane-1,3-diol, 2,4-diethyloctane-1,3-diol, neopentyl glycol hydroxypivalate, ditrimethylolpropane, dipentaerythritol, 2,2-bis(4-hydroxycyclohexyl)propane, 1,1-, 1,2-, 1,3- and 1,4-cyclohexane-dimethanol, 1,2-, 1,3- or 1,4-cyclohexanediol, or mixtures thereof. These polyisocyanates containing urethane and/or allophanate groups generally have an NCO content of 12% to 20% by weight and an average NCO functionality of 2.5 to 4.5.
5) Polyisocyanates comprising oxadiazinetrione groups, preferably derived from hexamethylene diisocyanate or isophorone diisocyanate. Polyisocyanates of this kind comprising oxadiazinetrione groups are obtainable from diisocyanate and carbon dioxide.
6) Polyisocyanates comprising iminooxadiazinedione groups, preferably derived from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.

The polyisocyanates 1) to 8) can be employed in a mixture, including if appropriate a mixture with diisocyanates.

Preferred use is made as component f) of isophorone diisocyanate, 1,3- and 1,4-bis(isocyanatomethyl)cyclohexane, their isocyanurates, biurets, and mixtures thereof.

Where the dispersions of the invention comprise not only component a) but also a component f), the fraction of the compounds of component f) is preferably 0.1% to 90%, more preferably 1% to 50%, in particular 5% to 30%, by weight based on the total amount of the compounds of components a) and f).

### Component g)

Thermal initiators g) for the purposes of the present invention are those which have a half-life at 60° C. of at least one hour. The half-life of a thermal initiator is the time taken for half the initial amount of the initiator to decompose into free radicals.

Thermal initiators are mandatorially absent in accordance with the invention, and are therefore present in amounts of less than 0.1% by weight.

### Component h)

The dispersion of the invention may comprise at least one further compound such as is normally employed as a reactive diluent. These include, for example, the reactive diluents as described in P.K.T. Oldring (editor), Chemistry & Technology of UV & EB Formulations for Coatings, Inks & Paints, Vol. II, Chapter III: Reactive Diluents for UV & EB Curable Formulations, Wiley and SITA Technology, London 1997.

Preferred reactive diluents are compounds different from component b) which have at least one free-radically polymerizable C═C double bond.

Examples of reactive diluents include esters of (meth)acrylic acid with alcohols which have 1 to 20 carbon atoms, e.g., methyl (meth)acrylate, ethyl (meth)acrylate, butyl (meth)acrylate, 2-ethylhexyl (meth)acrylate, 2-hydroxyethyl acrylate, 4-hydroxybutyl acrylate, dihydrodicyclopentadienyl acrylate, vinylaromatic compounds, e.g., styrene, divinylbenzene, α,β-unsaturated nitriles, e.g., acrylonitrile, methacrylonitrile, α,β-unsaturated aldehydes, e.g., acrolein, methacrolein, vinyl esters, e.g., vinyl acetate, vinyl propionate, halogenated ethylenically unsaturated compounds, e.g., vinyl chloride, vinylidene chloride, conjugated unsaturated compounds, e.g., butadiene, isoprene, chloroprene, monounsaturated compounds, e.g., ethylene, propylene, 1-butene, 2-butene, isobutene, cyclic monounsaturated compounds, e.g., cyclopentene, cyclohexene, cyclododecene, N-vinylformamide, allylacetic acid, vinylacetic acid, monoethylenically unsaturated carboxylic acids having 3 to 8 carbon atoms and also their water-soluble alkali metal, alkaline earth metal or ammonium salts, such as, for example: acrylic acid, methacrylic acid, dimethylacrylic acid, ethacrylic acid, maleic acid, citraconic acid, methylenemalonic acid, crotonic acid, fumaric acid, mesaconic acid, and itaconic acid, maleic acid, N-vinylpyrrolidone, N-vinyl lactams, such as N-vinylcaprolactam, N-vinyl-N-alkylcarboxamides or N-vinyl-carboxamides, such as N-vinylacetamide, N-vinyl-N-methylformamide, and N-vinyl-N-methylacetamide or vinyl ethers, e.g., methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether, 4-hydroxybutyl vinyl ether, and mixtures thereof.

Compounds having at least two free-radically polymerizable C═C double bonds: these include, in particular, the diesters and polyesters of the aforementioned α,β-ethylenically unsaturated monocarboxylic and/or dicarboxylic acids with diols or polyols. Particularly preferred are hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, pentaerythritol diacrylate, dipentaerythritol tetraacrylate, dipentaerythritol triacrylate, pentaerythritol tetraacrylate, etc. Also preferred are the esters of alkoxylated polyols, with α,β-ethylenically unsaturated monocarboxylic and/or dicarboxylic acids, such as the polyacrylates or polymethacrylates of alkoxylated trimethylolpropane, glycerol or pentaerythritol. Additionally suitable are the esters of alicyclic diols, such as cyclohexanediol di(meth)acrylate and bis(hydroxymethylethyl)cyclohexane di(meth)acrylate. Further suitable reactive diluents are trimethylolpropane monoformal acrylate, glycerol formal acrylate, 4-tetrahydropyranyl acrylate, 2-tetrahydropyranyl methacrylate, and tetrahydrofurfuryl acrylate.

Further suitable reactive diluents are for example epoxy (meth)acrylates, urethane (meth)acrylates, polyether (meth)acrylates, polyester (meth)acrylates or polycarbonate (meth)acrylates.

Urethane (meth)acrylates are obtainable for example by reacting polyisocyanates with hydroxyalkyl (meth)acrylates or hydroxyalkyl vinyl ethers and, if appropriate, chain extenders such as diols, polyols, diamines, polyamines, dithiols or polythiols.

Urethane (meth)acrylates of this kind comprise as synthesis components substantially:
(1) at least one organic aliphatic, aromatic or cycloaliphatic di- or polyisocyanate, such as those listed above under a),
(2) at least one compound having at least one isocyanate-reactive group and at least one free-radically polymerizable unsaturated group, such as the alcohols A listed above or those listed earlier on above under b), and
(3) if appropriate, at least one compound having at least two isocyanate-reactive groups, such as those listed below under c).

Components (1), (2), and (3) may be the same as those described above for the polyurethanes of the invention.

The urethane (meth)acrylates preferably have a number-average molar weight Mₙ of 500 to 20 000, in particular of 500 to 10 000 and more preferably 600 to 3000 g/mol (determined by gel permeation chromatography using tetrahydrofuran and polystyrene as standard).

The urethane (meth)acrylates preferably have a (meth)acrylic group content of 1 to 5, more preferably of 2 to 4, mol per 1000 g of urethane (meth)acrylate.

Particularly preferred urethane (meth)acrylates have an average OH functionality of 1.5 to 4.5.

Epoxy (meth)acrylates are preferably obtainable by reacting epoxides with (meth)acrylic acid. Examples of suitable epoxides include epoxidized olefins, aromatic glycidyl ethers or aliphatic glycidyl ethers, preferably those of aromatic or aliphatic glycidyl ethers.

Examples of possible epoxidized olefins include ethylene oxide, propylene oxide, iso-butylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxy-propoxy)phenyl]octahydro-4,7-methano-5H-indene) (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Preference is given to bisphenol A diglycidyl ether, bisphenol F diglycidyl ether, bisphenol B diglycidyl ether, and bisphenol S diglycidyl ether, and bisphenol A diglycidyl ether is particularly preferred.

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)-poly(oxypropylene) (CAS No. [16096-30-3]) and of hydrogenated bisphenol A (2,2-bis[4-(2,3-epoxypropoxy)cyclohexyl]propane, CAS No. [13410-58-7]).

Preference is given to 1,4-butanediol diglycidyl ether, 1,6-hexanediol diglycidyl ether, trimethylolpropane triglycidyl ether, pentaerythritol tetraglycidyl ether, and 2,2-bis[4-(2,3-epoxypropoxy)cyclohexyl]propane.

The abovementioned aromatic glycidyl ethers are particularly preferred.

The epoxy (meth)acrylates and epoxy vinyl ethers preferably have a number-average molar weight Mₙ of 200 to 20 000, more preferably of 200 to 10 000 g/mol, and very preferably of 250 to 3000 g/mol; the amount of (meth)acrylic or vinyl ether groups is preferably 1 to 5, more preferably 2 to 4, per 1000 g of epoxy (meth)acrylate or vinyl ether epoxide (determined by gel permeation chromatography using polystyrene as standard and tetrahydrofuran as eluent).

Preferred epoxy (meth)acrylates have an OH number of 40 to 400 mg KOH/g.

Preferred epoxy (meth)acrylates have an average OH functionality of 1.5 to 4.5.

Particularly preferred epoxy (meth)acrylates are those such as are obtained from processes in accordance with EP-A-54 105, DE-A 33 16 593, EP-A 680 985, and EP-A-279 303, in which in a first stage a (meth)acrylic ester is prepared from (meth)acrylic acid and hydroxy compounds and in a second stage excess (meth)acrylic acid is reacted with epoxides.

Suitable hydroxy compounds include compounds having one or more hydroxyl groups. Mention may be made of monoalcohols, e.g., C₁-C₂₀ alkanols or alkoxylated alcohols having a remaining OH group, C₂-C₈ alkylenediols, trimethylpropane, glycerol or pentaerythritol, or compounds comprising hydroxyl groups and alkoxylated, for example, with ethylene oxide and/or propylene oxide, examples being the compounds specified above under a) or b) or the compounds specified below under c).

Preferred hydroxy compounds are saturated polyesterols which comprise at least 2, in particular 2 to 6, free hydroxyl groups and which if appropriate may also comprise ether groups, or polyetherols having at least 2, in particular 2 to 6, free hydroxyl groups.

The molecular weights Mₙ of the polyesterols and/or polyetherols are preferably between 100 and 4000 (Mₙ determined by gel permeation chromatography using polystyrene as standard and tetrahydrofuran as eluent).

Hydroxyl-containing polyesterols of this kind can be prepared, for example, in customary fashion by esterifying dicarboxylic or polycarboxylic acids with diols or polyols. The starting materials for hydroxyl-containing polyesters of this kind are known to the skilled worker.

As dicarboxylic acids it is possible with preference to use succinic acid, glutaric acid, adipic acid, sebacic acid, o-phthalic acid, their isomers and hydrogenation products, and also esterifiable derivatives, such as anhydrides, maleic anhydride for example, or dialkyl esters of said acids. As polycarboxylic acid and/or anhydrides thereof, mention may be made of tribasic or tetrabasic acids such as trimellitic anhydride or benzenetetracarboxylic acid.

Preferred diols suitably include ethylene glycol, propylene-1,2-glycol and -1,3-glycol, butane-1,4-diol, hexane-1,6-diol, neopentyl glycol, cyclohexanedimethanol, and also polyglycols of the ethylene glycol type having a molar mass of 106 to 2000, polyglycols of the propylene glycol type having a molar mass of 134 to 2000, or polyTHF having a molar mass of 162 to 2000.

Polyols include primarily trimethylolbutane, trimethylolpropane, trimethylolethane, neopentyl glycol, neopentyl glycol hydroxypivalate, pentaerythritol, 2-ethyl-1,3-propane-diol, 2-methyl-1,3-propanediol, 2-ethyl-1,3-hexanediol, glycerol, ditrimethylolpropane, dipentaerythritol, 2,2-bis(4-hydroxycyclohexyl)propane, 1,1-, 1,2-, 1,3-, and 1,4-cyclo-hexanedimethanol, 1,2-, 1,3- or 1,4-cyclohexanediol, or sugar alcohols such as, for example, sorbitol, mannitol, diglycerol, threitol, erythritol, adonitol (ribitol), arabitol (Iyxitol), xylitol, dulcitol (galactitol), maltitol or isomalt.

Also suitable as diols or polyols are oxalkylated (with ethylene oxide and/or propylene oxide, for example) diols or polyols, particularly those having a degree of oxalkylation of 0 to 20, preferably 0-15, more preferably 0-10, and very preferably 1-5, based on the respective hydroxyl groups of the diol or polyol.

Preferred among these are in each case the products alkoxylated exclusively with ethylene oxide.

The polyesterols which can be used also include polycaprolactonediols and -triols, whose preparation is likewise known to the skilled worker.

Suitable hydroxyl-containing polyetherols include, for example, those which may be obtained by known processes, by reacting dihydric and/or polyhydric alcohols with different amounts of ethylene oxide and/or propylene oxide. It is also possible, similarly, to use polymerization products of tetrahydrofuran or of butylene oxide or of iso-butylene oxide.

Preferred hydroxyl-containing polyethers are oxalkylation products of the abovementioned diols or polyols, especially those having a degree of oxalkylation of 0 to 20, more preferably 1 to 15, very preferably 1-7 and in particular 1-5, based on the respective hydroxyl groups of the diol or polyol, but where in total there are at least 2 alkoxy groups in the polyether.

In the case of the esterification of (meth)acrylic acid in the instance of the hydroxyl-containing polyester it is, for example, also possible to introduce the (meth)acrylic acid as an initial charge together with starting materials of the hydroxyl-containing polyester, examples being dicarboxylic acids or their anhydrides and diols and/or polyols, and to react the starting materials together with the (meth)acrylic acid in one stage.

For the esterification of (meth)acrylic acid with the hydroxy compound the processes known to the skilled worker are suitable.

In the esterification of (meth)acrylic acid with the hydroxy compound it is preferred to use 0.1 to 1.5, more preferably 0.5 to 1.4, and very preferably 0.7 to 1.3 equivalents of (meth)acrylic acid per hydroxy equivalent of the hydroxy compounds. In the abovementioned case of starting the esterification from the starting materials, e.g., of the hydroxyl-comprising polyester, the equivalents of the (meth)acrylic acid are based on the hydroxy equivalent remaining theoretically after reaction of the starting materials, e.g., reaction of dicarboxylic acids with diols or polyols.

The reaction of (meth)acrylic acid with the hydroxy compounds can be carried out for example in the presence of an acidic esterification catalyst, such as sulfuric acid, p-toluenesulfonic acid, dodecylbenzenesulfonic acid or acidic ion exchangers, and also in the presence of a hydrocarbon that forms an azeotropic mixture with water, and can be carried out in particular up to a conversion of, for example, at least 80%, preferably at least 85%, more preferably 90% to 98%, and in particular 90-95%, of the hydroxyl groups of the hydroxy compound, at 60 to 140° C., for example. The water of reaction formed is removed azeotropically. Suitable hydrocarbons are aliphatics and aromatics, e.g., alkanes and cycloalkanes, such as pentane, n-hexane, n-heptane, methylcyclohexane, and cyclohexane, aromatics such as benzene, toluene, and the xylene isomers, and products known as special-boiling-point spirits, which have boiling limits between 70 and 140° C.

In order to prevent premature polymerization the reaction with (meth)acrylic acid is advantageously conducted in the presence of small amounts of inhibitors. These are the customary compounds used to prevent thermal polymerization, of the type, for example, of hydroquinone, of hydroquinone monoalkyl ethers, especially hydroquinone monomethyl ether, of 2,6-di-tert-butylphenol, of N-nitrosoamines of phenothiazines, of phosphorous esters or of hypophosphorous acid. They are used generally in amounts of 0.001 to 2.0%, preferably in amounts of 0.005 to 0.5%, based on the reaction in the first stage.

Following the esterification the solvent, the hydrocarbon for example, can be removed from the reaction mixture by distillation, under reduced pressure if appropriate. The esterification catalyst can be neutralized in a suitable way, such as by adding tertiary amines or alkali metal hydroxides. Excess (meth)acrylic acid, too, can be removed in part by distillation, for example, under reduced pressure.

Prior to the beginning of the reaction in the second stage, the reaction product of the first stage generally still has an acid number (AN) of more than 20, preferably of 30 to 300, more preferably of 35 to 250 mg KOH/g solids (without solvent).

In the second stage, the reaction product obtained in the first stage is reacted with one or more epoxide compounds, preferably one epoxide compound. Epoxide compounds are those having at least one, preferably having at least two, more preferably two or three, epoxide groups in the molecule.

Suitable examples include epoxidized olefins, glycidyl esters (e.g., glycidyl (meth)acrylate) of saturated or unsaturated carboxylic acids, or glycidyl ethers of aliphatic or aromatic polyols. Products of this kind are available commercially in large number. Particularly preferred are polyglycidyl compounds of the bisphenol A, F or B type and glycidyl ethers of polyfunctional alcohols, e.g., of butanediol, of 1,6-hexane-diol, of glycerol, and of pentaerythritol. Examples of polyepoxide compounds of this kind are Epikote® 812 (epoxide value: about 0.67 mol/100 g) and Epikote® 828 (epoxide value: about 0.53 mol/100 g), Epikote® 1001, Epikote® 1007 and Epikote® 162 (epoxide value: about 0.61 mol/100 g) from Resolution, Rütapox® 0162 (epoxide value: about 0.58 mol/100 g), Rütapox® 0164 (epoxide value: about 0.53 mol/100 g), and Rütapox® 0165 (epoxide value: about 0.48 mol/100 g) from Bakelite AG, and Araldit® DY 0397 (epoxide value: about 0.83 mol/100 g) from Huntsman.

The epoxide compounds are added to the reaction product obtained in the first stage generally in amounts of more than 10%, preferably 15% to 95%, and more preferably 15% to 70%, by weight, based on the reaction mixture of the first stage (without solvent). With very particular preference the epoxide compounds are used in approximately equimolar amounts, based on the acid equivalents still present in the reaction product of the first stage.

In the course of reaction with epoxide compounds in the second stage, unreacted acid or acid used in excess, especially (meth)acrylic acid, but also, for example, hydroxy compounds or dicarboxylic acid still present as starting material in the mixture, or resultant monoesters of dicarboxylic acids, having a remaining acid group, is bonded as epoxide ester.

The reaction with epoxide compounds can be accelerated by adding catalysts. Examples of suitable catalysts include tertiary alkylamines, tertiary alkylamino alcohols, tetraalkylammonium salts, as described in EP 686621 A1, p. 4, II. 9-41.

Carbonate (meth)acrylates comprise on average preferably 1 to 5, especially 2 to 4, more preferably 2 to 3 (meth)acrylic groups, and very preferably 2 (meth)acrylic groups.

The number-average molecular weight Mₙ of the carbonate (meth)acrylates is preferably less than 3000 g/mol, more preferably less than 1500 g/mol, very preferably less than 800 g/mol (determined by gel permeation chromatography using polystyrene as standard, tetrahydrofuran as solvent).

The carbonate (meth)acrylates are obtainable in a simple manner by transesterifying carbonic esters with polyhydric, preferably dihydric, alcohols (diols, hexanediol for example) and subsequently esterifying the free OH groups with (meth)acrylic acid, or else by transesterification with (meth)acrylic esters, as described for example in EP-A 92 269. They are also obtainable by reacting phosgene, urea derivatives with polyhydric, e.g., dihydric, alcohols.

In an analogous way it is also possible to obtain vinyl ether carbonates, by reacting a hydroxyalkyl vinyl ether with carbonic esters and also, if appropriate, with dihydric alcohols.

Also conceivable are (meth)acrylates or vinyl ethers of polycarbonate polyols, such as the reaction product of one of the aforementioned diols or polyols and a carbonic ester and also a hydroxyl-containing (meth)acrylate or vinyl ether.

Examples of suitable carbonic esters include ethylene carbonate, 1,2- or 1,3-propylene carbonate, dimethyl carbonate, diethyl carbonate or dibutyl carbonate.

Examples of suitable hydroxyl-containing (meth)acrylates are 2-hydroxyethyl (meth)acrylate, 2- or 3-hydroxypropyl (meth)acrylate, 1,4-butanediol mono(meth)acrylate, neopentyl glycol mono(meth)acrylate, glyceryl mono- and di(meth)acrylate, trimethylolpropane mono- and di(meth)acrylate, and pentaerythrityl mono-, -di-, and tri(meth)acrylate.

Suitable hydroxyl-containing vinyl ethers are, for example, 2-hydroxyethyl vinyl ether and 4-hydroxybutyl vinyl ether.

Particularly preferred carbonate (meth)acrylates are those of the formula:

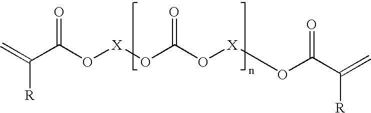

in which R is H or CH₃, X is a C₂-C₁₈ alkylene group, and n is an integer from 1 to 5, preferably 1 to 3.

R is preferably H and X is preferably C₂ to C₁₀ alkylene, examples being 1,2-ethylene, 1,2-propylene, 1,3-propylene, 1,4-butylene, and 1,6-hexylene, more preferably C₄ to C₈ alkylene. With very particular preference X is C₆ alkylene.

The carbonate (meth)acrylates are preferably aliphatic carbonate (meth)acrylates.

They further include customary polycarbonates known to the skilled worker and having terminal hydroxyl groups, which are obtainable, for example, by reacting the aforementioned diols with phosgene or carbonic diesters.

Polyether (meth)acrylates are, for example, mono(meth)acrylates of polyTHF having a molar weight between 162 and 2000, poly-1,3-propanediol having a molar weight between 134 and 2000, or polyethylene glycol having a molar weight between 238 and 2000.

Where the dispersions of the invention are cured not with electron beams but instead by means of UV radiation, the preparations of the invention preferably comprise at least one photoinitiator which is able to initiate the polymerization of ethylenically unsaturated double bonds.

Photoinitiators may be, for example, photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds), SITA Technology Ltd, London.

Suitability is possessed, for example, by mono- or bisacylphosphine oxides, as described for example in EP-A 7 508, EP-A 57 474, DE-A 196 18 720, EP-A 495 751 or EP-A 615 980, examples being 2,4,6-trimethylbenzoyldiphenylphosphine oxide (Lucirin® TPO from BASF AG), ethyl 2,4,6-trimethylbenzoylphenylphosphinate (Lucirin® TPO L from BASF AG), bis(2,4,6-trimethylbenzoyl)phenylphosphine oxide (Irgacure® 819 from Ciba Spezialitätenchemie), benzophenones, hydroxyaceto-phenones, phenylglyoxylic acid and its derivatives, or mixtures of these photoinitiators. Examples that may be mentioned include benzophenone, acetophenone, acetonaphthoquinone, methyl ethyl ketone, valerophenone, hexanophenone, α-phenyl-butyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diisopropylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7H-benzoin methyl ether, benz[de]anthracene-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxy-acetophenone, benzil ketals, such as benzil dimethyl ketal, 2-methyl-1-[4-(methylthio)-phenyl]-2-morpholinopropan-1-one, anthraquinones such as 2-methylanthraquinone, 2-ethylanthraquinone, 2-tert-butylanthraquinone, 1-chloroanthraquinone, and 2-amyl-anthraquinone, and 2,3-butanedione.

Also suitable are nonyellowing or low-yellowing photoinitiators of the phenylglyoxalic ester type, as described in DE-A 198 26 712, DE-A 199 13 353 or WO 98/33761.

Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethylpentyl-phosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethylpentyl-phosphine oxide and 1-hydroxycyclohexyl phenyl ketone, 2,4,6-trimethylbenzoyl-diphenylphosphine oxide and 2-hydroxy-2-methyl-1-phenylpropan-1-one, 2,4,6-tri-methylbenzophenone and 4-methylbenzophenone or 2,4,6-trimethylbenzophenone, and 4-methylbenzophenone and 2,4,6-trimethylbenzoyidiphenylphosphine oxide.

Preference among these photoinitiators is given to 2,4,6-trimethylbenzoyldiphenylphosphine oxide, ethyl 2,4,6-trimethylbenzoylphenylphosphinate, bis(2,4,6-tri-methylbenzoyl)phenylphosphine oxide, benzophenone, 1-benzoylcyclohexan-1-ol, 2-hydroxy-2,2-dimethylacetophenone, and 2,2-dimethoxy-2-phenylacetophenone.

The dispersions of the invention comprise the photoinitiators preferably in an amount of 0.05% to 10%, more preferably 0.1% to 8%, in particular 0.2% to 5%, by weight based on the total amount of components a) to h).

The dispersions of the invention may comprise further customary coatings additives, such as flow control agents, defoamers, UV absorbers, dyes, pigments and/or fillers.

Suitable fillers comprise silicates, e.g., silicates obtainable by hydrolysis of silicon tetrachloride, such as Aerosil R from Degussa, siliceous earth, talc, aluminum silicates, magnesium silicates, and calcium carbonates, etc. Suitable stabilizers comprise typical UV absorbers such as oxanilides, triazines, and benzotriazole (the latter obtainable as Tinuvin R grades from Ciba-Spezialitätenchemie), and benzophenones. They can be used alone or together with suitable free-radical scavengers, examples being sterically hindered amines such as 2,2,6,6-tetramethyl-piperidine, 2,6-di-tert-butylpiperidine or derivatives thereof, e.g., bis(2,2,6,6-tetramethyl-4-piperidyl) sebacate. Stabilizers are used usually in amounts of 0.1% to 5.0% by weight, based on the “solid” components comprised in the preparation.

### Component k)

Polyamines having 2 or more primary and/or secondary amino groups can be used in particular when the chain extension and/or crosslinking is to take place in the presence of water, since amines generally react quicker with isocyanates than do alcohols or water. This is often necessary when aqueous dispersions of crosslinked polyurethanes or polyurethanes of high molar weight are desired. In such cases the procedure is to prepare prepolymers containing isocyanate groups, to disperse them rapidly in water, and then, by adding compounds having two or more isocyanate-reactive amino groups, to subject them to chain extension or crosslinking.

Amines suitable for this purpose are generally polyfunctional amines of the molar weight range from 32 to 500 g/mol, preferably from 60 to 300 g/mol, which comprise at least two primary, two secondary or one primary and one secondary amino group(s). Examples of such are diamines such as diaminoethane, diaminopropanes, diaminobutanes, diaminohexanes, piperazine, 2,5-dimethylpiperazine, amino-3-amino-methyl-3,5,5-trimethylcyclohexane (isophoronediamine, IPDA), 4,4′-diaminodicyclo-hexylmethane, 1,4-diaminocyclohexane, aminoethylethanolamine, hydrazine, hydrazine hydrate or triamines such as diethylenetriamine or 1,8-diamino-4-amino-methyloctane, or higher amines such as triethylenetetramine, tetraethylenepentamine or polymeric amines such as polyethyleneamines, hydrogenated polyacrylonitriles, or at least partially hydrolyzed poly-N-vinylformamides, in each case with a molar weight of up to 2000, preferably up to 1000 g/mol.

The amines can also be employed in blocked form, e.g., in the form of the corresponding ketimines (see, e.g., CA-1 129 128), ketazines (cf., e.g., U.S. Pat. No. 4,269,748) or amine salts (see U.S. Pat. No. 4,292,226). Oxazolidines as well, as are used, for example, in U.S. Pat. No. 4,192,937, represent capped polyamines, which can be used for preparing the polyurethanes for chain-extending the prepolymers. When using capped polyamines of this kind they are generally blended with the prepolymers in the absence of water and this mixture is subsequently mixed with the dispersion water or with a portion of the dispersion water, so that the corresponding polyamines are liberated by hydrolysis.

It is preferred to use mixtures of diamines and triamines, more preferably mixtures of isophoronediamine and diethylenetriamine.

The fraction of polyamines can be up to 10 mol %, preferably up to 8 mol %, and more preferably up to 5 mol %, based on the total amount of C═C double bonds.

The solids content of the aqueous dispersions of the invention is preferably situated within a range from about 5% to 70%, in particular 20% to 50% by weight.

The composition of the polyurethanes of the invention per 100 mol % of reactive isocyanate groups in a) and f) (in total) is generally as follows:
b) 30 to 99.9 mol %, preferably 40 to 99.5 mol %, more preferably 50 to 99 mol %, very preferably 60 to 97 mol %, and in particular 70 to 95 mol %,
c) 0 to 20 mol %, preferably 0 to 15 mol %, more preferably 0 to 10 mol %, very preferably 0 to 5 mol %, and in particular 0 mol %,
d) 0.1 to 40 mol %, preferably 0.5 to 35 mol %, more preferably 1 to 30 mol %, very preferably 3 to 25 mol %, and in particular 5 to 15 mol %,
e) up to 10 mol %, preferably up to 8 mol %, more preferably up to 5 mol %, very preferably up to 2 mol %, and in particular 0 mol %,
   with the proviso that the sum of all the isocyanate-reactive groups is 80 to 125 mol % of the reactive isocyanate groups in a) and f) (in total), preferably 85 to 115 mol %, more preferably 90 to 110 mol %, very preferably 95 to 105 mol %, and in particular 100 mol %.

The ratio of a) to f), based on the reactive isocyanate groups, is generally 1:0 to 1:2, preferably 1:0 to 1:1.5, more preferably 1:0 to 1:1.2, very preferably 1:0 to 1:1, in particular 1:0 to 1:0.5 and especially 1:0.

The number-average molecular weight Mₙ of the polyurethanes of the invention, determined by gel permeation chromatography using tetrahydrofuran as eluent and polystyrene as standard, can amount for example to up to 50 000, preferably up to 30 000, more preferably up to 10 000, in particular up to 5000, and especially up to 2000. In addition the molecular weight may amount to up to 1500 or even up to 1000.

The isocyanate group content, calculated as NCO with the molecular weight 42 g/mol, is up to 5% by weight in the polyurethanes of the invention, preferably up to 3% by weight, more preferably up to 2% by weight, very preferably up to 1% by weight, and in particular up to 0.5% by weight. If blocked isocyanate groups are comprised then they are included in the calculation of the isocyanate group content.

For the preparation of the polyurethanes of the invention the starting components a), b), and d), and also, if appropriate, c), e), and f), are reacted with one another at temperatures of 40 to 180° C., preferably 50 to 150° C., while observing the NCO/OH equivalent ratio specified above.

The reaction generally takes place until the desired NCO number to DIN 53185 has been reached.

The reaction time is generally 10 minutes to 12 hours, preferably 15 minutes to 10 hours, more preferably 20 minutes to 8 hours, and very preferably 1 to 8 hours.

The reaction can if appropriate be accelerated using suitable catalysts.

The formation of the adduct of isocyanato-functional compound and the compound comprising groups that are reactive toward isocyanate groups takes place generally by mixing the components in any order, at elevated temperature if appropriate.

Preferably the compound comprising groups that are reactive toward isocyanate groups is added to the isocyanato-functional compound, more preferably in two or more steps.

With particular preference the isocyanato-functional compound is introduced initially and the compounds comprising isocyanate-reactive groups are added. In particular the isocyanato-functional compound a) is introduced first of all, and then b) and subsequently d) are added, or, preferably, the isocyanato-functional compound a) is introduced first of all, and then d) and subsequently b) are added. After that it is possible if appropriate to add further desired components.

It will be appreciated that b) and d) can also be added in a mixture with one another.

For the preparation of the polyurethane dispersion the polyurethane prepared is mixed with water. Preferably, in a first step, the organic phase is prepared homogeneously and, in a second step, this organic phase is introduced into a water phase or a water phase is introduced into the organic phase thus prepared.

Within the dispersion prepared in this way the average particle size (z-average), measured by means of dynamic light scattering using the Malvern® Autosizer 2 C, is generally <1000 nm, preferably <500 nm, and more preferably <100 nm. Normally the diameter is 20 to 80 nm.

Producing the emulsion generally necessitates an energy input of not more than 10⁸ W/m³.

The dispersions of the invention are particularly suitable for coating substrates such as wood, paper, textile, leather, nonwoven, plastics surfaces, glass, ceramic, mineral building materials, such as cement moldings and fiber-cement slabs, and, in particular, for coating metals or coated metals.

After curing by means of high-energy radiation, the dispersions of the invention advantageously form films having good performance properties, such as good scratchability, chemical resistance, weathering stability and/or good mechanical properties.

The substrates are coated in accordance with customary methods that are known to the skilled worker, involving the application of at least one dispersion of the invention to the substrate that is to be coated, in the desired thickness, and removal of the volatile constituents of the dispersions. This process can be repeated one or more times if desired. Application to the substrate may take place in a known way, e.g., by spraying, troweling, knifecoating, brushing, rolling, roller-coating or pouring. The coating thickness is generally situated within a range from about 3 to 1000 g/m² and preferably 10 to 200 g/m².

To remove the water comprised in the dispersion it is dried following application to the substrate, drying taking place for example in a tunnel oven or by flashing off. Drying can also take place by means of NIR radiation, NIR radiation here meaning electromagnetic radiation in the wavelength range from 760 nm to 2.5 μm, preferably from 900 to 1500 nm.

If appropriate, if two or more films of the coating material are applied one on top of another, a radiation cure may take place after each coating operation.

Radiation curing is accomplished by exposure to high-energy radiation, i.e., UV radiation or daylight, preferably light with a wavelength of 250 to 600 nm, or by irradiation with high-energy electrons (electron beams; 150 to 300 keV). Examples of radiation sources used include high-pressure mercury vapor lamps, lasers, pulsed lamps (flash light), halogen lamps or excimer emitters. The radiation dose normally sufficient for crosslinking in the case of UV curing is situated within the range from 80 to 3000 mJ/cm².

Irradiation may also if appropriate be carried out in the absence of oxygen, e.g., under an inert gas atmosphere. Suitable inert gases include, preferably, nitrogen, noble gases, carbon dioxide or combustion gases. Irradiation may also take place with the coating material being covered by transparent media. Transparent media are, for example, polymeric films, glass or liquids, e.g., water. Particular preference is given to irradiation in the manner as is described in DE-A1 199 57 900.

In one preferred process, curing takes place continuously, by passing the substrate treated with the preparation of the invention at constant speed past a radiation source. For this it is necessary for the cure rate of the preparation of the invention to be sufficiently high.

This varied course of curing over time can be exploited in particular when the coating of the article is followed by a further processing step in which the film surface comes into direct contact with another article or is worked on mechanically.

The advantage of the dispersions of the invention is that the coated articles can be processed further immediately following the radiation cure, since the surface is no longer sticky. On the other hand, the dried film is still sufficiently flexible and stretchable that the article can still be deformed without the film flaking or tearing.

The invention further provides for the use of a dispersion, as described above, for coating substrates of metal, wood, paper, ceramic, glass, plastic, textile, leather, nonwoven, or mineral building materials.

The polyurethane dispersions of the invention can be used in particular as primers, surfacers, pigmented topcoat materials, and clearcoat materials in the sectors of industrial coating, especially aircraft coating or large-vehicle coating, wood coating, automotive finishing, especially OEM finishing or automotive refinish, or decorative coating. The coating materials are especially suitable for applications where particularly high application reliability, exterior weathering stability, optical qualities, solvent resistance and/or chemical resistance are required.

The invention is illustrated by means of the following, nonlimiting examples.

### EXAMPLES

Unless indicated otherwise, parts and percentages indicated are by weight.

### Polyisocyanate A:

Prepared as polyisocyanate A was a polyisocyanate containing allophanate groups, prepared from hexamethylene 1,6-diisocyanate and 2-hydroxyethyl acrylate in a manner analogous to that of example 1 of WO 00/39183, so that, following distillative removal of the unreacted hexamethylene 1,6-diisocyanate (residual monomer content <5% by weight), a polyisocyanate was obtained which had an NCO content of 14.9%, a viscosity at 23° C. of 1200 mPas and a double bond density, determined by ¹H NMR of 2 mol/kg.

### Polyether A:

Monofunctional polyethylene oxide prepared starting from methanol with potassium hydroxide catalysis, having an OH number of 112, measured in accordance with DIN 53 240, corresponding to a molecular weight of 500 g/mol. The catalyst residues still present were subsequently neutralized with acetic acid. The basicity is found to be 10.6 mmol/kg, by titration with HCl.

### Example 1

In a reaction vessel provided with stirrer, thermometer and reflux condenser, 141 g of polyisocyanate A with 0.1 g of 4-methoxyphenol and 0.2 g of Kerobit® TBK (2,6-di-tert-butyl-p-cresol from Raschig, as stabilizers) were admixed with 29 g of 2-hydroxyethyl acrylate. When dibutyltin dilaurate catalyst was added, an exothermic reaction was observed, accompanied by a temperature increase to about 65° C. Reaction was then continued at 55° C. for 15 minutes. Thereafter 50 g of polyether A and 75 g of Capa 212 (polycaprolactone diol from Solvay, molar mass 1000 g/mol, OH number 113 mg KOH/g) were added; again there was evolution of heat, and the temperature of the batch rose to about 68° C. After a reaction time of 2 hours at 65° C. the water-dispersibility of the product was very good. Its NCO content is 0%; the viscosity was 93 000 mPa*s.

For the purpose of dispersion, a solution of 100 g of the product thus obtained in 77 ml of acetone was admixed with 124 ml of water, with stirring. Subsequently the acetone was distilled off under reduced pressure and the remaining solution was diluted with 60 ml of water. The dispersion obtained in this way has a solids content of 35%, a viscosity of 3 mPa*s, and an average particle size of 256.4 nm.

Dispersing 100 g of the resin obtained in 185 ml of water using a dissolver gave a finely particulate, blueish dispersion having a solids content of 35%, a viscosity of 4 mPa*s, and an average particle size of 67.3 nm.

### Example 2

In a reaction vessel provided with stirrer, thermometer and reflux condenser, 282 g of polyisocyanate A with 0.2 g of 4-methoxyphenol and 0.4 g of Kerobit®TBK (2,6-di-tert-butyl-p-cresol from Raschig, as stabilizers) were admixed with 87 g of 2-hydroxyethyl acrylate. When dibutyltin dilaurate catalyst was added, an exothermic reaction was observed. Reaction was then continued at 60° C. for 15 minutes. Thereafter 125 g of polyether B were added. After a reaction time of 3.5 hours at 65° C. the water-dispersibility of the product was very good.

Its NCO content is 0%; the viscosity was 2410 mPa*s.

### Example 3

In a reaction vessel provided with stirrer, thermometer and reflux condenser, 282 g of polyisocyanate A with 0.2 g of 4-methoxyphenol and 0.4 g of Kerobit® TBK (2,6-di-tert-butyl-p-cresol from Raschig, as stabilizers) were admixed with 360.4 g of pentaerythrityl triacrylate. When dibutyltin dilaurate catalyst was added, an exothermic reaction was observed. Reaction was then continued at 60° C. for 30 minutes. Thereafter 150 g of polyether B were added. After a reaction time of 3.5 hours at 65° C. the water-dispersibility of the product was very good.

Its NCO content is 0%; the viscosity was 15 700 mPa*s.

1: A radiation-curable dispersible polyurethane synthesized from
a) at least one compound having at least two free isocyanate groups, at least one allophanate group, and at least one free-radically polymerizable C═C double bond attached via the allophanate group, which is attached directly to the double bond a carbonyl group or an oxygen atom in ether function,
b) at least one compound having at least one group that is reactive toward isocyanate groups, and at least one free-radically polymerizable C═C double bond,
c) optionally, at least one compound having at least two groups that are reactive toward isocyanate groups, selected from the group consisting of hydroxyl, mercapto, and primary and/or secondary amino groups,
d) at least one compound having precisely one group that is reactive toward isocyanate, and at least one dispersive group, the dispersive group a monofunctional polyalkylene oxide polyether alcohol d3) which contains at least 5 and up to 50 ethylene oxide units
e) optionally, at least one compound different from b) and d), containing precisely one group that is reactive toward isocyanate groups, and
f) optionally, at least one polyisocyanate different from a).

2. A polyurethane dispersion comprising further to the dispersible polyurethane according to claim 1 the following components:
g) absence of a thermal initiator,
h) optionally, further additives, selected from the group consisting of reactive diluents, photoinitiators, and customary coatings additives,
i) water, and
k) optionally, at least one diamine and/or polyamine.

3. The polyurethane according to claim 1, which has a double bond density of at least 1.3 mol/kg.

4. The polyurethane according to claim 1, wherein low molecular weight alcohols c1) having a molecular weight of not more than 500 g/mol are present exclusively as component c).

5. The polyurethane according to claim 1, wherein no component c) is present.

6. (canceled)

7. The polyurethane according to claim 1, wherein the composition of the polyurethane per 100 mol % of reactive isocyanate groups in a) and f) (in total) is as follows:
b) 30 to 99.9 mol %,
c) 0 to 20 mol %,
d) 0.1 to 40 mol %,
e) up to 10 mol %,
with the proviso that the sum of all the isocyanate-reactive groups is 80 to 125 mol % of the reactive isocyanate groups in a) and f) (in total).

8. The polyurethane according to claim 1, wherein the ratio of a) to f), based on the reactive isocyanate groups, is from 1:0 to 1:2.

9. The polyurethane dispersion according to claim 2, wherein the average particle size (z-average), measured by dynamic light scattering with the Malvern® Autosizer 2 C, is <1000 nm.

10. A substrate coated with a polyurethane dispersion according to claim 2.

11. A method of coating a substrate, which comprises applying a polyurethane dispersion according to claim 2 to a substrate, followed by drying and radiation curing.

12. (canceled)

13. The polyurethane dispersion according claim 2, wherein low molecular weight alcohols c1) having a molecular weight of not more than 500 g/mol are present exclusively as component c).

14. The polyurethane dispersion according to claim 2, wherein no component c) is present.

15. The polyurethane dispersion according to claim 2, wherein the composition of the polyurethane per 100 mol % of reactive isocyanate groups in a) and f) (in total) is as follows:
b) 30 to 99.9 mol %,
c) 0 to 20 mol %,
d) 0.1 to 40 mol %,
e) up to 10 mol %,
with the proviso that the sum of all the isocyanate-reactive groups is 80 to 125 mol % of the reactive isocyanate groups in a) and f) (in total).

16. The polyurethane dispersion according to claim 2, wherein the ratio of a) to f), based on the reactive isocyanate groups, is from 1:0 to 1:2.
